(19) United States
(12) Patent Application Publication
(10) Pub. No.: US 2014/0318032 A1
(43) Pub. Date: Oct. 30, 2014

(54) Snow Guard

(71) Applicant: Jeffrey J. McCarthy, Springville, NY (US)

(72) Inventor: Jeffrey J. McCarthy, Springville, NY (US)

(21) Appl. No.: 13/871,220

(22) Filed: Apr. 26, 2013

(51) Int. Cl. E04D 13/10; B23P 15/00

(52) U.S. Cl. CPC E04D 13/10; B23P 15/00
USPC 52/24; 29/428

(57) ABSTRACT

The present invention is a snow guard comprising a base and a faceplate. The base has a generally flat bottom surface with screw holes for securing the snow guard to a roof surface. The base has sides, triangular in the preferred embodiment, extending upwardly from the bottom surface and a front base support having two angled extensions forming a gap between the two extensions and the triangular sides of the base. The faceplate fits into the gap, thereby assisting in securing the faceplate to the base. The faceplate has a center plate and wings. The wings are angled to increase support against accumulated snow and ice. The base and the faceplate are fastened together by mechanical force, without the need for adhesives or welding.

### CROSS REFERENCE TO RELATED APPLICATIONS

This application claims the benefit of U.S. Provisional Application of Jeffery McCarthy, Ser. No. 61/639,382, filed 27 Apr. 2012, having the title SNOW GUARD, which is incorporated herein by reference in its entirety

### BACKGROUND OF THE INVENTION

1. Field of the Invention

This invention relates generally to retaining devices. More specifically, the present invention relates to a snow guard for installation on a sloped roof to prevent the sudden and unexpected sliding of snow from the roof.

2. Background

In geographic regions which receive substantial snowfall, the hazards of falling snow or ice are a major concern. In areas with greater snowfall, roofs tend to be constructed with steeper pitches in order to allow the snow to slide from the roof slope to avoid excessive snow loads on the roof structure. Ice accumulates on a metal roof when snow melts and re-freezes, or freezing rain occurs after a snowfall. When temperatures rise and the ice begins to melt a slide will more likely occur where the roof surface is made of metal. In addition, the metal surface reflects heat which causes melting and freezing causing snow to change to ice.

Snow build up is a gradual process on sloped roofs. It does not usually slide from a sloped structure immediately upon contacting that structure. Rather, the first snow tends to adhere to the underlying structure, with additional snow adhering to the first snow. The buildup continues until a significant amount of snow has accumulated on the structure. Under proper conditions, when a sufficient mass of snow in combination with sufficient heat radiation through the roof structure to melt the snow immediately adjacent to the roof, the snow tends to change to ice and release from the sloped structure all at once. Falling ice/snow is extremely hazardous for anything immediately beneath the roof.

Snow guards have long been in use, however, problems persist with failure and resulting damage to structures beneath the roof. Failure of a snow guard can result from a weakness of various elements of the guard, including, but not limited to, the faceplate that holds the snow back, snow and ice forming underneath the snow guard thereby weakening the support structure, the means of attachment of the snow guard to the roof, and the means of fastening or attaching the various elements of the snow guard together.

Additionally, snow stops are frequently installed in a number and position that is not ideal for the type of roof and the amount of snow and ice. Further, snow guards may be inherently too weak to withstand a certain threshold force applied to its projecting restrainer. The poor performance of the prior art in this field suggests a strong, and long-felt, need for development of a more effective snow guard.

Design of snow guards, such that when properly positioned on a roof, work cooperatively to have a synergistic effect on the prevention of snow slides would be a significant advancement in the field. A novel snow guard that could withstand extreme pressures and can be systematically positioned on a roof so that the combined holding power of a group of snow guards is more than the combined holding power of the same number of snow guards measured individually would be of great commercial success in the marketplace.

### SUMMARY OF THE INVENTION

It is a primary object of the present invention to prevent the accidental or unplanned sliding or avalanching of snow from an inclined roof. This object is achieved by the present invention, which is a snow guard comprising a base and a faceplate. The base has a generally flat bottom surface with screw holes for securing the snow guard to a roof surface. The base has sides, triangular in the preferred embodiment, although not limited to triangular, extending upwardly from the bottom surface and a front base support having two angled extensions forming a gap between the two extensions and the triangular sides of the base. The faceplate fits into the gap, thereby assisting in securing the faceplate to the base. The faceplate has a center plate and wings. The wings are angled to increase support against accumulated snow and ice. The base and the faceplate are fastened together by mechanical force, without the need for adhesives or welding.

Yet another object of the present disclosure is to provide a snow guard that is configured to withstand high pressures of large amounts of snow and ice on the roof.

A further object of the present disclosure is to provide a snow guard that has a winged faceplate that increases the strength and holding power of a multiplicity of snow guards on a roof. The winged element of the faceplate is designed such that, when properly positioned and aligned, the wing shape of the faceplate contributes a synergistic effect on resisting snow pressure.

A further object of the present disclosure is to provide a snow guard that possesses a weep hole so as to allow for irrigation of melting snow and ice on a roof.

Additional objects and advantages will become apparent and a more thorough and comprehensive understanding may be had from the following description and claims taken in conjunction with the accompanying drawings forming a part of this specification.

The snow guard of the present invention is significantly stronger than known snow stop devices. Comparable snow guards fail with a far lower level of force exerted on their restraining members than do snow guards of the present disclosure. Unlike the prior art, the snow guard of the present invention has two members, a base and a faceplate, fastened together without welding or adhesives. In one embodiment of the present invention, the base and the faceplate are formed from flat sheets of metal by first stamping the sheets to form flat precursors to the base and the faceplate. Once shaped, the base has sides that fasten to the faceplate with tags that fit into holes in the faceplate. The tags are then crimped to fasten the base to the faceplate, resulting in a stronger and more reliable snow guard in comparison to snow guards having welded or adhered members. Furthermore, the present invention has a front base support with extensions that angle upwards to prevent the faceplate from being driven forward and down by accumulation of snow and ice behind the faceplate, which can contribute to failure in prior art devices. Additionally, in one embodiment, the present invention is formed by stamping and bending specific types of aluminum alloy to form the base and faceplate, rather than casting metal to shape the snow guard. The types of aluminum alloy, 6063-T5 for the faceplate and 6061-T6 for the base, preferred in the present invention, bent into shape rather than cast, significantly enhances the strength of the snow guard.

### BRIEF DESCRIPTION OF THE DRAWINGS

The present invention and the manner in which it may be practiced is further illustrated with reference to the accompanying drawings wherein:

FIG. 1 is a back perspective view of the present disclosure of a snow guard.

FIG. 2 is a bottom view of the present disclosure of a snow guard.

FIG. 3 is a back view of the present disclosure of a snow guard.

FIG. 4 is a front view of the present disclosure of a snow guard

FIGS. 5 and 6 are side views of the present disclosure of a snow guard.

FIG. 7 is a top view of the present disclosure of a snow guard.

FIG. 8 is a bottom view of the present disclosure of a snow guard.

FIG. 9 is an environmental perspective view of the snow guard of the present disclosure, showing exemplary installation of multiple snow guards atop of the slanted roof.

FIG. 10 is an exploded view of support members and base separated from the faceplate.

FIG. 11 is a front view of the snow guard of the present disclosure showing faceplate connected to base plate.

### DETAILED DESCRIPTION OF THE INVENTION

At the outset, it should be clearly understood that like reference numerals are intended to identify the same structural elements, portions, or surfaces consistently through out the several drawing figures, as may be further described or explained by the entire written specification of which this detailed description is an integral part. The drawings are intended to be read together with the specification and are to be construed as a portion of the entire “written description” of this invention as required by 35 U.S.C. §112.

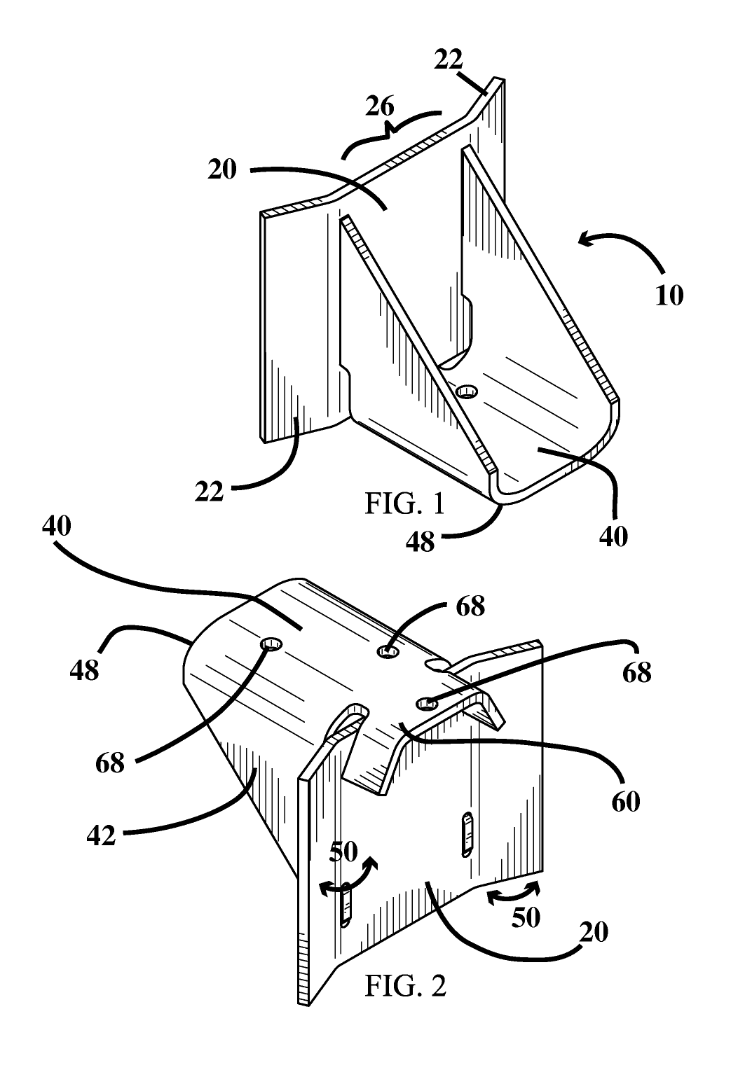

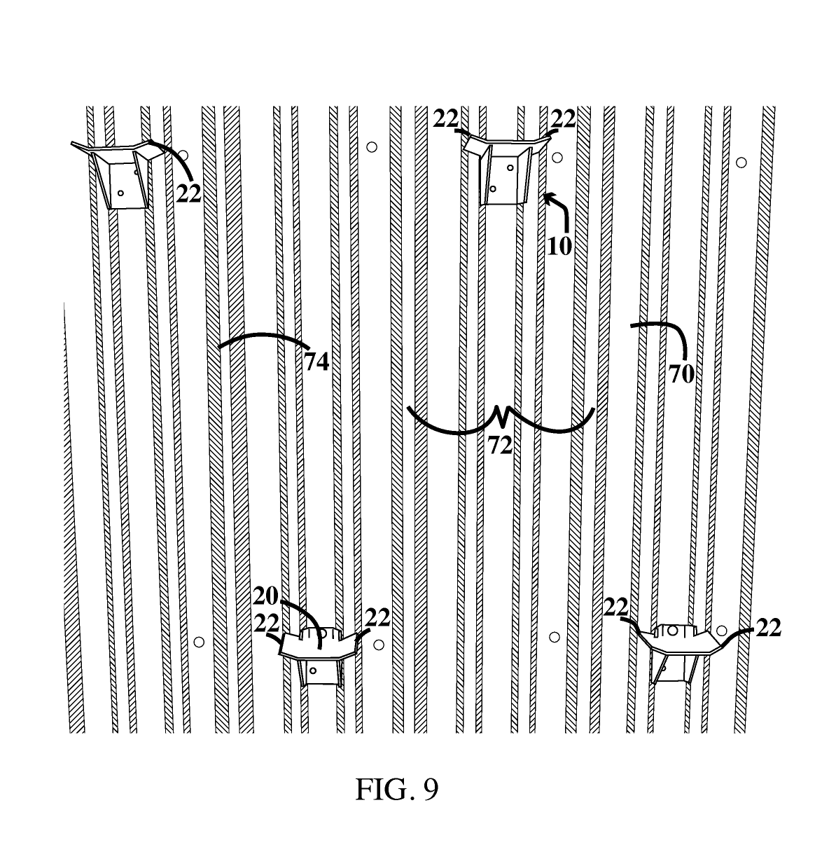

Adverting now to the drawings, with reference to FIG. 1, a preferred embodiment of the snow guard of the present invention is indicated generally by numeral 10. As shown in the drawings for purposes of illustration, the invention is embodied in a snow guard 10 which is fastened to a downwardly inclined roof 70 (see FIG. 9) or a downwardly inclined portion of building facia, or the like to restrain ice and/or snow from sliding downwardly onto people, automobiles, open porches or the like. For the sake of convenience, the term “roof” shall be used generally to mean not only a roof but also an inclined surface of a facia, covered walkway structure, or to whatever the snow guard is fastened.

The snow guard has a base 40 that is fastened to the inclined roof and includes faceplate 20 projecting upwardly from the base and for engaging ice or snow accumulated on the roof. The roof may be made of various materials and shapes. Herein, the roof is illustrated as being a metal roof formed of a series of adjacent metal sections or panels 72 that have upwardly projecting side edges flanges 74 that are overlapped to form a seam between adjacent panels (See FIG. 9).

The sun heats metal roof sections and the snow or ice between the seams tends to form, at times, into long sheets that slide down metal roofs. Sometimes, long sheets of ice may project over the roofs edge. The snow guard is intended to hold the ice and snow sheet against sliding off the roof in a big sheet or from hanging over the roofs edge and then dropping onto and damaging people and property.

FIG. 1 is a back perspective view of the present disclosure of snow guard 10. Snow guard 10 is generally comprised of faceplate 20 which is supported by base 40. Faceplate 20 is comprised of center plate 26 and wings 22. Wings 22 are bent forward at an angle relative to the center plate in a range of about 135° to 165° and are generally shown by arrows 50 in FIG. 2. In the preferred embodiment of the disclosure the snow guard is made from extruded flat stock aluminum. Aluminum is preferred over other metal alloys because of the physical properties of aluminum such as: lower oxidization and therefore it does not rust, malleability and tensile strength, and once aluminum is formed it increases in hardness over time.

FIG. 2 is a bottom perspective view of the present disclosure of a snow guard. The base plate is comprised of a sheet of metal that is bent at radius or curved corner 48 so that support member 42 extends upward from the base to configure a relatively triangular side as support for faceplate 20. Base plate 40 is bent upward to form the triangular side 42 forming curved corner 48. A curved corner that gradually increases at an angle until it forms support member 42 that is extended from base plate at 90° angle relative to the base is preferred over a straight edge corner. By curving the corner the faceplate is positioned or raised about ⅛ of an inch off the roof and the strength of the bend is about 70% stronger because the stretch of metal is less on the radius of the curve. In addition, metal roofs are standardized having minor and major elevated ribs and the curved corners of the base plate are constructed to mesh/match with the minor raised ribs of the standard metal roof. The minor ribs of the standard metal roof extend out at a 45° angle relative to the base of the roof and the curved corner fills the space of the angle. A base with a curved corner remains flush with the roof, whereas a 90° straight edge corner would leave space for movement of the snow guard. In addition the distance between the ribs on the standard metal roof is standard and uniform and the width of the base is about equivalent to the distance between the ribs on the roof.

It should be appreciated that other suitable metal alloys can be used in the manufacture of the snow guard, but the preferred aluminum alloy from which the base plate is constructed has sufficient hardness to withstand the high pressures of ice and snow that accumulates on a roof, but is also malleable to form the curved corner between the base and support member 42 and maintain the integrity of the metal. The snow guard is constructed from a flat piece of sheet aluminum alloy that is bent and shaped to form the support members. The base plate preferably has 6063-T5 aluminum alloy properties for optimal tensile strength and malleability. If an aluminum alloy with properties of greater hardness and tensile strength were used in the process of manufacturing a curved corner, the aluminum would snap or break or remain a weak point. The preferred aluminum alloy for the faceplate is constructed using a sheet of aluminum having standard 6061-T6 aluminum alloy properties, which would relative to the base has greater hardness and is more brittle and has less malleability. The faceplate should be able to withstand the extreme pressures of the snow and ice buildup on a roof and does not need to be curved or formed as the base corner.

Base 40 has front base support 60 which includes fastening hole 68 to provide for greater holding power not only to the metal roof but also to support the faceplate from pitching forward or pitching backward. Fastening hole 68 can accommodate any means known in the art to fasten and attach snow guards to metal roof such as screws or nails. In the preferred embodiment of this invention fastening holes are used to accommodate screws. It is also common in the art to use of adhesive to increase the holding power of the screws to maintain contact of the base plate to the roof.

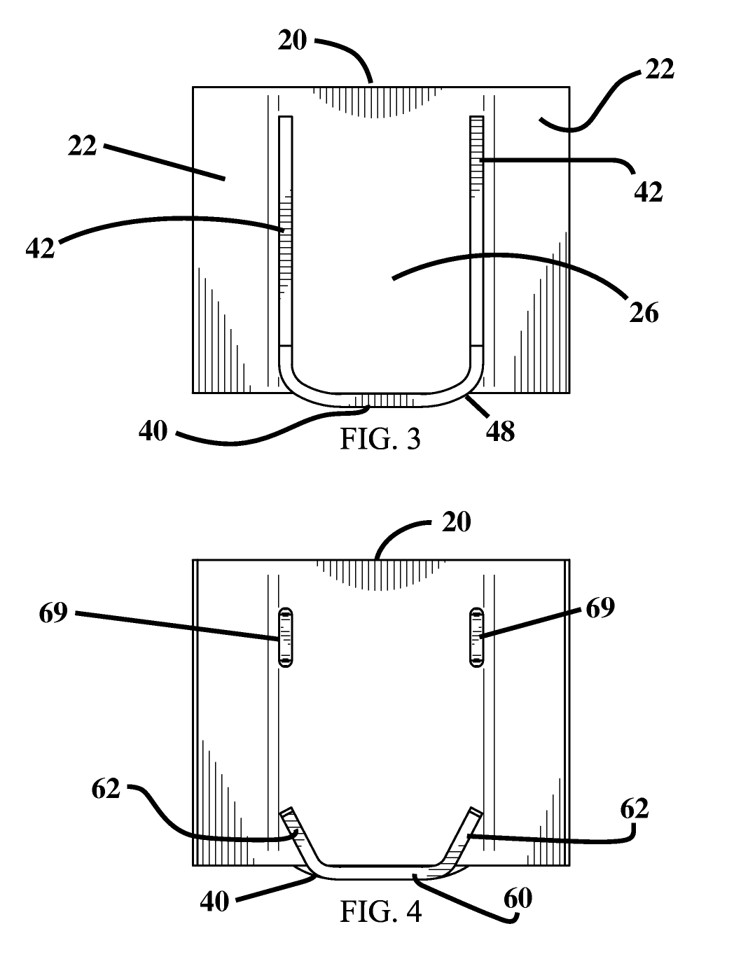

FIG. 3 is a back view of the present disclosure of a snow guard. Faceplate 20 is a separate sheet of metal attached to and supported by base 40. Base 40 has support members 42 which are generally triangular shaped and extend essentially the height of faceplate 20. The middle section of faceplate 20 is generally identified as center plate 26. Wings 22 of faceplate 20 extend generally from support member 42 away from the center plate.

FIG. 4 is a front view of the present disclosure of a snow guard showing that front base support 60 extends and supports the faceplate 20 by front base extensions 62 which each keep faceplate from pitching forward. Base plate 40 is comprised of support members 42 which each have a staking tab 69 which are extensions which protrude through apertures in faceplate 20 and hold faceplate in place. In the preferred embodiment of this disclosure staking tabs 69 are pushed through holes in the faceplate and are crimped so as to maintain a rigidly secured hold of faceplate 20.

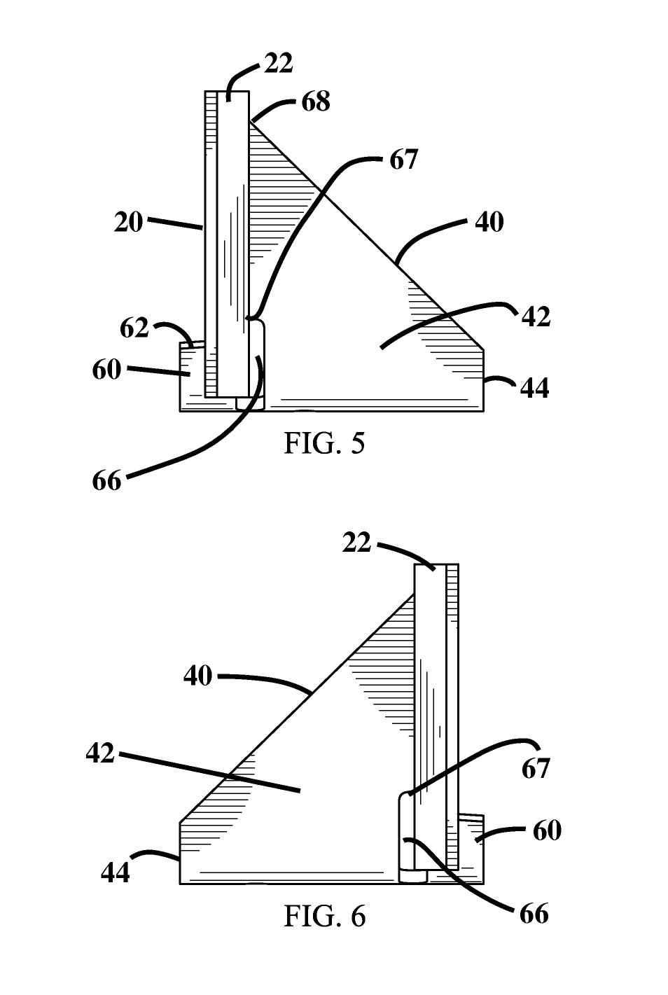

FIGS. 5 and 6 are side views of the present disclosure of a snow guard showing that base 40 is configured to have triangular side brace support members 42 which are generally configured in the shape of a right triangle. The triangle shaped side brace support members provide a backstop for the faceplate. Support members 42 are shaped in a right triangle, the portion of the triangle extending up from the base at about a 90° angle supports the faceplate from pitching backward when ice or snow presses against the faceplate. Support members contact faceplate along a line in a plane from contact point 68 to contact point 67. Each support members have a relatively c-shaped aperture or weep hole 66 which is a space formed between front base extension 62 and the lower portion of brace support members 42 not in contact with faceplate 20. Support member back extensions 44 are positioned at approximately a 90° angle relative to base 40. Support member 42 extends upward from back extensions 44 at a 45° angle to about the top edge of faceplate 20. Extensions 44 extend up from the base at a 90° angle and provide added support for faceplate of the snow guard. The portion of the side brace support members which contact the faceplate extends to about ¼″ from top of the faceplate. The sidewalls supports the faceplate and therefore it should be understood that increased surface area which contacts the faceplate increases the strength of the support of the side brace members.

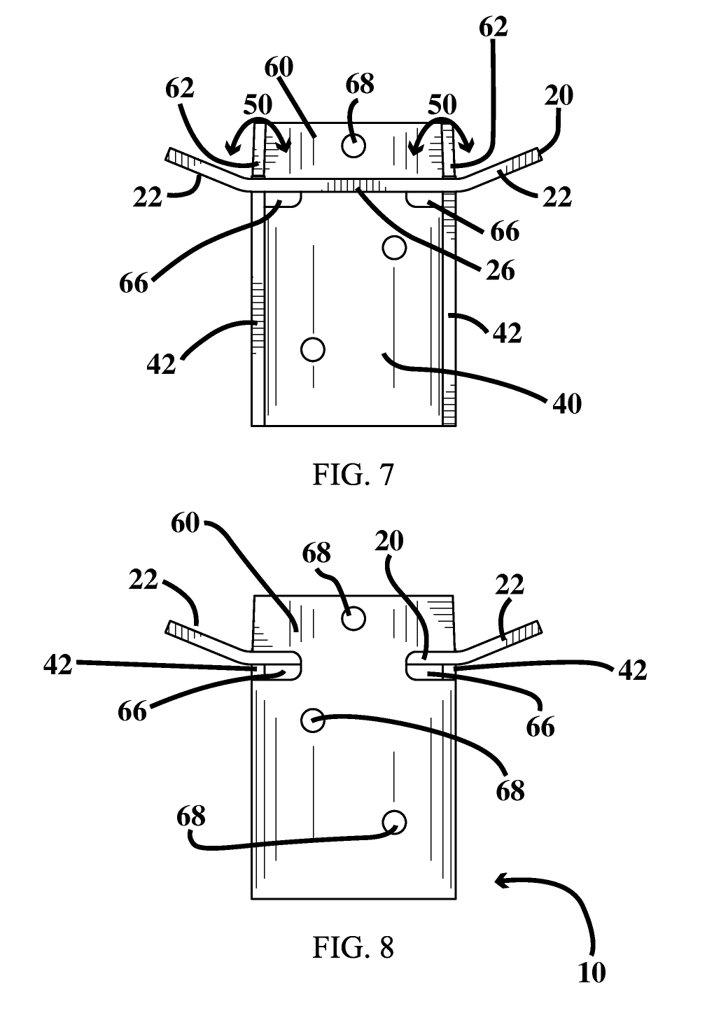

FIG. 7 is a top view of the present disclosure of a snow guard showing faceplate 20 connected to base 40. Arrows 50 generally show that wings 22 of faceplate 20 are bent forward at an angle relative to the center plate in a range of between 135° and 165°. Front base support 60 supports faceplate 20 with front base extensions 62. Each extension supports the front side of faceplate 20 and along with support members 42 creates weep holes 66. Weep holes 66 allow for water produced from melted ice and snow to freely pass through and around the base plate and the faceplate. This view also shows how support members 42 support faceplate 20 from pitching backward.

FIG. 8 is a bottom view of the present disclosure of a snow guard showing faceplate 20 connected to base 40. Weep hole 66 is formed at the base of snow guard 10 proximate front base extension 60. Weep hole 66 allows for faceplate 20 to be seated between front base extension 60 and support members 42. Screws holes 68 on bottom of base plate are offset relative to a straight line down the middle of the base plate. Screws are driven through the roof to the roof purlings that are spaced every 2 feet below the metal roof. When driving screws into the wood purling at straight lines it's more likely to split the wood and decrease the holding power of the snow guard as well as decrease the integrity of the roof. By staggering the screw holes the snow guards are safely installed on the roof and are able to withstand greater pressure exerted by the ice and snow.

FIG. 9 is an environmental perspective view of the snow guard showing exemplary installation of multiple snow guards atop of the slanted roof. Illustrated are a plurality of metal snow guards, which are installed atop a roof. These snow guards are preferably screwed into the roof in a defined pattern for maximum efficiency to prevent the falling of unwanted and sometimes dangerous snow or ice that is located upon the roof. The brackets are attached toward the bottom of the slanted roof and are positioned so the winged extension of each snow guard is lined up in an imaginary plane so that it intersects the wing of an adjacent spaced snow guard.

Having a multiplicity of snow guards on the roof stops the large pieces of snow and ice from falling from the roof at one time. Because each faceplate on each snow guard is working in conjunction with each other, large pieces of snow and ice are maintained on the roof while the snow slowly melts and drips from the roof. Each faceplate holds a specific surface area of each large section of ice and snow. Bending the edges of the snow guard face plates into side wings 22 increases the ice holding surface area and the tensile strength of the faceplate relative to a faceplate without winged the edges. By configuring the faceplate with wings that are bent forward at an angle relative to the center plate in a range of about 135° to 165° the surface area of the snow or ice that is being held is increased because it significantly increases the surface area of the faceplate along an imaginary plane. The angled wing extension on the face plate results in a stronger snow guard than a snow guard with a flat faceplate. These angled wings efficiently hold large portions of ice when wings 22 are bent forward at an angle relative to the center plate in a range of about 135° to 165° and set so that the wings imaginary plane extend outward to intersect with the wings of other snow guards spaced along the bottom portion of the roof.

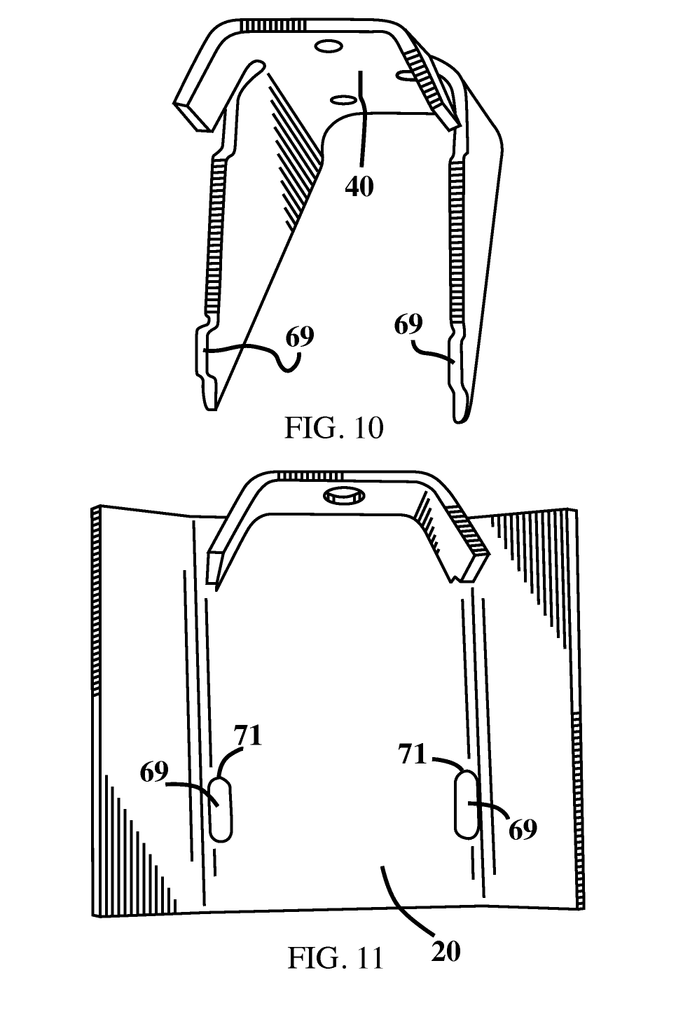

FIG. 10 is an exploded view of support members and base separated from the faceplate. Support members 42 each have a staking tab 69 which are extensions which extend outward from the support members through apertures in the faceplate, which are crimped to secure the faceplate to the base.

FIG. 11 is a front view the snow guard of the present disclosure showing faceplate connected to base plate. Base plate 40 is comprised of support member 42 which each have a staking tab 69 which are extensions which protrude through apertures 71 in faceplate 20 and hold faceplate in place.

Although the invention has been described with reference to certain preferred embodiments, it will be appreciated by those skilled in the art that modifications and variations may be made without departing from the spirit and scope of the invention. It should be understood that applicant does not intend to be limited to the particular details described above and illustrated in the accompanying drawings. In this regard, the term “means for” as used in the claims is intended to include not only the designs illustrated in the drawings of this application and the equivalent designs discussed in the text, but it is also intended to cover other equivalents now known to those skilled in the art, or those equivalents which may become known to those skilled in the art in the future.

What is claimed is:

1. A snow guard comprising:
a base having a generally flat bottom surface for securing said snow guard to a roof surface, wherein said base has sides extending upwardly from said bottom surface and a front base support having two angled extensions forming a gap between the two extensions and said sides for securing a faceplate to said base;
wherein said sides extend upwardly from said bottom surface at approximately a 90 degree angle relative to said bottom surface; and
said faceplate having a center plate and wings wherein said wings are angled away from said sides at an angle in a range of about 135° to 165° relative to said center plate.

2. The snow guard of claim 1 wherein said faceplate has apertures through which tabs from said sides enter wherein said tabs are crimped to secure the faceplate in position.

3. The snow guard of claim 2 is configured from an aluminum alloy

4. The snow guard of claim 3 wherein said base has 6063-T5 aluminum alloy properties for lower tensile strength and greater malleability relative to said faceplate.

5. The snow guard of claim 4 wherein said faceplate has 6061-T6 aluminum alloy properties which relative to the base has greater hardness and has lower malleability.

6. The snow guard of claim 5 wherein said base sides are triangular.

7. The snow guard of claim 6 wherein said base has staggered screw holes.

8. A snow guard comprising a faceplate supported by a base, wherein said base has side supports fastened to said faceplate and a front base support with angled extensions.

9. The snow guard of claim 8 wherein said faceplate is fastened to said base by crimping.

10. The snow guard of claim 9 wherein said faceplate is comprised of center plate and wings angled relative to said center plate in a range of about 135° to 165°.

11. The snow guard of claim 10 wherein said faceplate and said base are shaped by bending rather than casting.

12. The snow guard of claim 11 wherein said side of base is formed at approximately a 90° angle relative to said base.

13. The snow guard of claim 12 wherein said side of base is triangular.

14. The snow guard of claim 13 is configured from an aluminum alloy.

15. The snow guard of claim 14 wherein said base has 6063-T5 aluminum alloy properties for lower tensile strength and greater malleability relative to said faceplate.

16. The snow guard of claim 15 wherein said faceplate has 6061-T6 aluminum alloy properties which relative to the base has greater hardness and has lower malleability.

17. The snow guard of claim 16 wherein said base has staggered screw holes.

18. The snow guard of claim 17 wherein said base is secured to the roof with high pressure-resistant screws.

19. The snow guard of claim 18 wherein said base and said faceplate are shaped by bending.

20. A method for manufacturing a snow guard comprising the steps of:
Stamping a metal sheet to form a base precursor and stamping a metal sheet to form a faceplate precursor;
shaping said faceplate precursor and said base precursor; and
fastening said base to said faceplate by mechanical force rather than welding or adhesion.
